(19) United States
(12) Patent Application Publication
(10) Pub. No.: US 2025/0097640 A1
(43) Pub. Date: Mar. 20, 2025

(54) RECORDING AUDIO USING NEARFIELD RADIO RANGING

(71) Applicant: International Business Machines Corporation, Armonk, NY (US)

(72) Inventors: Jeffrey Bisti, New Paltz, NY (US); PHILIP SICONOLFI, Croton on Hudson, NY (US); Robert Paquin, Poughkeepsie, NY (US)

(21) Appl. No.: 18/467,969

(22) Filed: Sep. 15, 2023

(51) Int. Cl. H04R 3/12; G10L 25/60; H04S 3/00

(52) U.S. Cl. CPC H04R 3/12; G10L 25/60; H04S 3/008; H04R 2400/01; H04S 2400/11

(57) ABSTRACT

A mesh map of networked radio devices is maintained for recording audio of a target speaker using multiple radio devices. Relative locations of the radio devices are established according to audio signal quality received by the radio devices. A primary microphone assignment for recording the target speaker is dynamically assigned among the radio devices according to audio quality conditions. Additional roles of background audio microphone and speaker system may be assigned to other nearby radio devices.

### BACKGROUND

The present invention relates generally to the field of audio recording, and more particularly to establishing a recording framework using multiple recording devices.

Ultra-wideband (UWB), also known as ultraband, is a radio technology that uses very low energy levels for short-range, high-bandwidth communications over the radio spectrum.

### SUMMARY

In one aspect of the present invention, a method, a computer program product, and a system includes: identifying a plurality of radio devices for role assignment; locating a target speaker based on audio signal quality received by the plurality of radio devices; establishing a mesh map of the plurality of radio devices based on shared audio signal data from the plurality of radio devices, the mesh map locating a first device with respect to other devices; and assigning to the first device a role of primary microphone, the first device receiving a higher quality audio signal of the target speaker than the other devices.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a first method performed, at least in part, by the first embodiment system;

FIG. 3 is a schematic view of a machine logic (for example, software) portion of the first embodiment system;

FIG. 4 is a flowchart showing a second method according to the present invention;

FIG. 5 is a flowchart showing a third method according to the present invention; and

FIG. 6 is a mesh map view showing information that is generated by and/or helpful in understanding embodiments of the present invention.

### DETAILED DESCRIPTION

A mesh map of networked radio devices is maintained for recording audio of a target speaker using multiple radio devices. Relative locations of the radio devices are established according to audio signal quality received by the radio devices. A primary microphone assignment for recording the target speaker is dynamically assigned among the radio devices according to audio quality conditions. Additional roles of background audio microphone and speaker system may be assigned to other nearby radio devices. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), crasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not storage in the form of one or more transitory signals, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as radio device manager 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

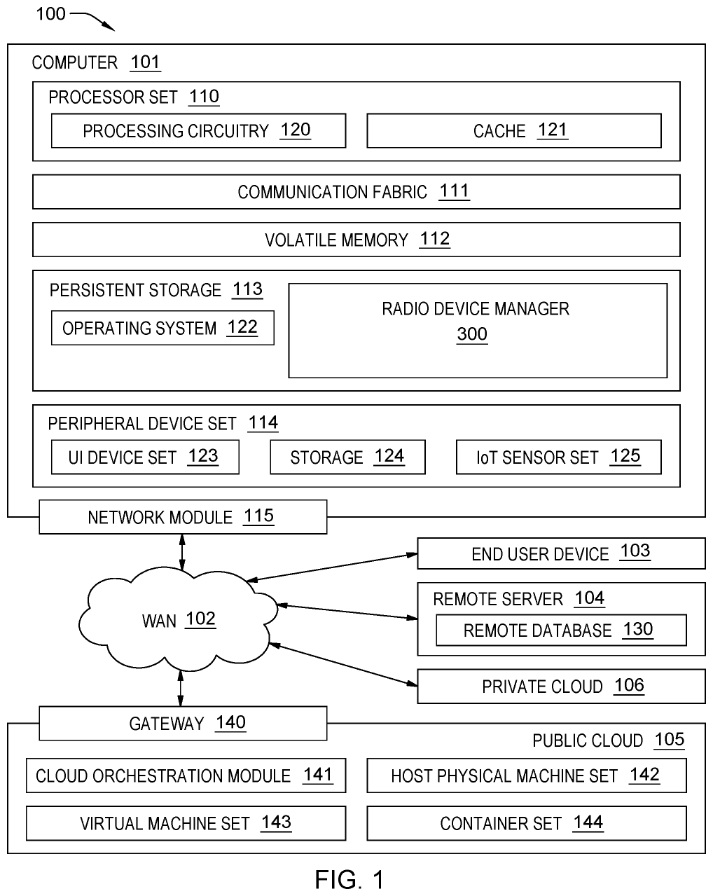

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Radio device manager 300 operates to use identified radio devices in a mesh network for tracking and recording a target speaker. The radio devices are assigned various roles according to their proximity to the target speaker. The assigned roles are revisited according to relative movement of the target speaker and/or relative locations of identified radio devices.

Conventional approaches to recording audio of a target speaker in a meeting is to capture as much audio as possible during the meeting, relying on processing the recorded audio after the fact. Post-processing techniques such voice isolation and/or background audio removal are used to make the voice of a target speaker stand out in the recording. Post-processing recorded audio does not address the issue of placement of the microphone and/or speaker relative to the target speaker.

Some embodiments of the present invention address certain foundational concepts when recording the voice of a target speaker in a meeting because audio is subject to the inverse square law. For example, crinkling paper proximate an active microphone will be louder than the voice of a target speaker a further distance away from the microphone. Another foundational concept addressed by some embodiments of the present invention is that meeting participants are often very good at reconstructing dialog when they have additional context for evaluating the source of the audio. Absent of visual and spatial cues, it becomes much more difficult to identify a target speaking voice in an audio recording.

For example, when using a standard web conferencing client, a meeting participant who is whispering next to the microphone of their online access device is heard by other meeting participants at the same volume as the voice of the presenter. Without a mechanism to configure a meeting space or event area and to assign participant roles, audio quality is limited. According to some embodiments of the present invention, participant roles are assigned on the basis of observation of participants in the meeting.

Some embodiments of the present invention recognize the following facts, potential problems and/or potential areas for improvement with respect to the current state of the art: (i) recording audio from gatherings in meeting or conference spaces with multiple speakers is difficult; (ii) recording audio from web conferences where multiple guests need to be connected is difficult; (iii) recording audio from fluid environments where people are moving and background conversations may be taking place away from the intended speaker; (iv) software audio processing is being dramatically advanced with AI; (v) microphones and speakers are becoming increasingly prevalent in devices; (vi) the fundamentals of audio (microphone placement and frequency filtering) preclude any software improvement; (vii) using multiple enable devices requires muting or otherwise disabling features of certain devices to counteract feedback and/or echo problems with the audio recording; (viii) the use of a lavalier or handheld microphone introduces phasing and/or flanging issues with the audio recording; and (ix) dedicated conference phones cannot distinguish between the voice of a target speaker and voices of background speakers within a distributed environment.

Some embodiments of the present invention recognize the following facts, potential problems and/or potential areas for improvement with respect to the current state of the art: (i) state of the art approaches to enhancing audio, analyze the audio itself to make the improvement; (ii) state of the art audio processing relies upon improving the effect of a speaker moving away from the microphone after the recording is completed; (iii) in order to ideally record a speaker, they need to be speaking into a single microphone, with no amplified speakers nearby; and (iv) it is known to increase audio quality recorded by mobile devices by training a machine learning model using previously recorded audio for enhancement using artificial intelligence.

Some embodiments of the present invention use fine ranging (FiRa) devices having ultra-wideband (UWB) communication technology to build a local “mesh map.” The nodes of the mesh map include specified audio recording capabilities. The spatial information of the mesh map is leveraged to optimize audio recording in a dynamic event space or region reserved for in-person meetings.

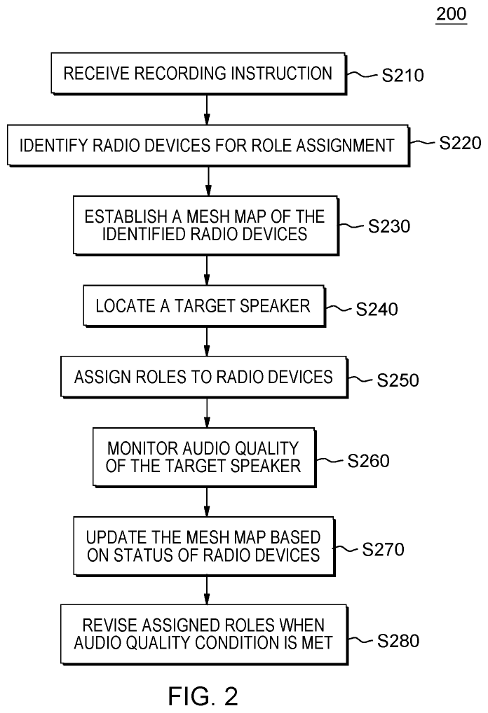

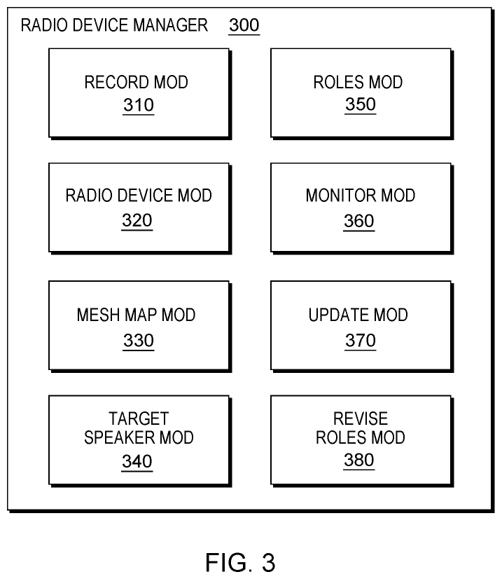

FIG. 2 shows flowchart 200 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S210, where record module (“mod”) 310 receives a recording instruction. The recording instruction initiates activity associated with recording audio at an event in which one or more primary speakers share oral information with participants, such as at a conference or meeting event. In this example, the recording instruction is received as a meeting schedule identifying the timeframe in which primary speakers should be recorded. Alternatively, the recording instruction is received from a user who decides when to begin recording the speaker(s) at an event.

Processing proceeds to step S220, where radio device mod 320 identifies radio devices for role assignment. In this example, fine-ranging (FiRa) radio devices are identified within communication range at a location where an event requires audio recording of primary speakers. FiRa technology enables precise location awareness for radio devices. In this example, any FiRa device in communication range of the event is identified for role assignment. Alternatively, FiRa devices are registered for participation so that at a designated location, date, and time range the registered FiRa devices are identified when they are within communication range of the event.

Processing proceeds to step S230, where mesh map mod 330 establishes a mesh map of the identified FiRa radio devices. The mesh map indicates which radio devices are engaged in the mesh network where radio devices are collaboratively used by assignment of various roles during an audio recording event. The mesh map is built by using FiRa radio devices to locate other similar devices and extrapolate the location data. In the mesh map, nodes represent radio devices and edges represent relative distances between the set of engaged radio devices.

Processing proceeds to step S240, where target speaker mod 340 locates a target speaker. A target speaker is identified using shared audio data from the set of identified radio devices along with using near-field radio ranging techniques to locate the various radio devices. In that way, the target speaker is acoustically isolated, as if a microphone were being passed from one speaker to another. In this example, the target speaker is identified through auditory queues, such as speaking rate or rhythm, voice timbre, pitch, intensity, and decibel level of speech. Alternatively, the target speaker is identified through geographic boundaries where various speakers switch. The boundaries may be based on pre-defined distances from a given microphone.

Processing proceeds to step S250, where roles mod 350 assigned roles to the identified radio devices. The various roles that may be assigned to individual radio devices includes: (i) primary microphone; (ii) background microphone; (iii) speaker-only; (iv) muted speaker; and (v) muted microphone. Assignment of roles includes at least assigning the primary microphone to the target speaker, which can change and/or move within the recording environment, or event space. Having a primary microphone assigned allows for designating certain nearby devices as a muted speaker role to prevent interference with the primary microphone. In this example, nearby devices are defined by a maximum distance from the primary microphone. Any devices located up to the maximum distance are assigned the role of muted microphone. Additionally, the role of background microphone may be assigned to those devices at the edge of the event space. In this case, the role may be assigned to those devices beyond a minimum distance from the primary microphone. The minimum distance may be a factor of the size of the recording environment and the number of devices making up the collaborative network.

Processing proceeds to step S260, where monitor mod 360 monitors audio quality of the target speaker. In this example, monitoring audio quality includes comparing audio quality of the primary microphone device to nearby microphones. This is achieved by sampling audio from devices within a specified range of the primary microphone. In some embodiments, the microphones are selectively unmuted to sample the audio quality of a given device.

Some embodiments of the present invention predict the next primary microphone according to a movement trajectory of the target speaker or by identifying improved audio quality at a microphone that is not the primary microphone. When a next primary microphone is identified, audio quality thresholds are specified for switching from one microphone to another.

Processing proceeds to step S270, where update mod 370 updates the mesh map based on statuses of the participating radio devices. In this example, device locations are monitored for a threshold distance of movement the mesh map is reviewed and updated. Alternatively, the a threshold number of devices each moving a minimum distance triggers an update of the mesh map. Further, when a new device is identified, the mesh map is updated with the new device location relative to the other participating devices. Additionally, when a networked device is no long visible or communicating with the network, the mesh map is updated to remove the missing device and establish a revised mesh map.

Processing ends at step S280, where revise roles mod 380 revises the assigned roles of the participating devices when an audio quality condition is met. In this example, when monitor mod 360 determines that an audio quality condition requires reassignment of roles, particularly the primary microphone role, a revision of the roles is initiated. Alternatively, when the mesh map is updated, the assigned roles are evaluated based on the updated mesh map to ensure that certain pre-defined rules are complied with, such as the mute microphone role and background microphone roles are often based on rules that govern assignment of the roles.

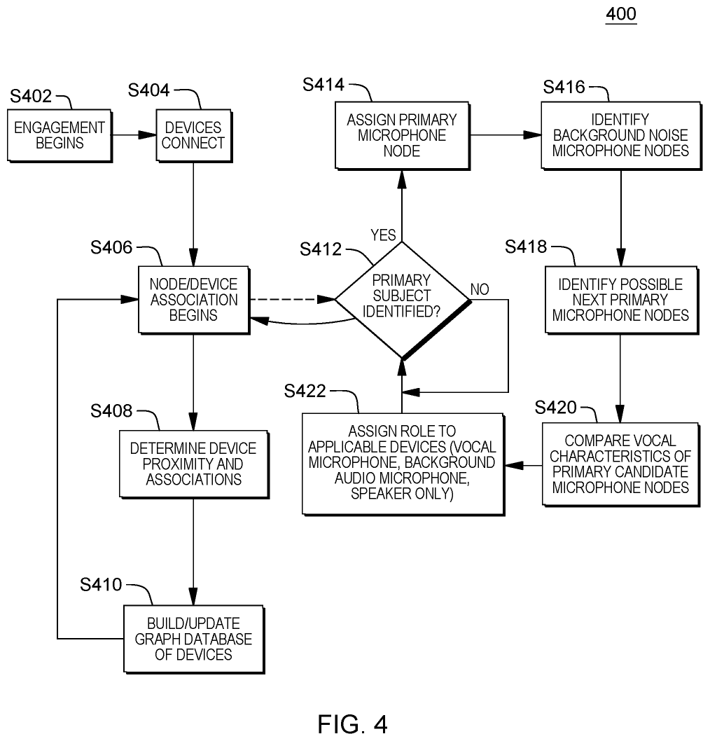

Further embodiments of the present invention are discussed in the paragraphs that follow and with reference to FIGS. 4-6.

FIG. 4 shows flowchart 400 depicting a second method according to an embodiment of the present invention. This method will now be discussed, over the course of the following paragraphs.

Some embodiments of the present invention are directed to providing for devices to join a mesh map, or mesh network, defining the dynamic space in which target speakers are to be recorded. The joining devices are assigned certain roles based on observations made with regard to distance and/or other characteristics of the mesh with respect to the target speaker or other devices in the mesh map.

Some embodiments of the present invention are directed to a framework for acoustically isolating a target speaker, as if to pass the microphone around to target speakers during a meeting.

According to flowchart 400, processing begins at step S402, where radio device engagement begins. Radio devices are identified for joining the mesh network for recording audio of an event hosting at least in part as an in-person conference. Some embodiments of the present invention facilitate grouping of participants of the in-person conference.

Process proceeds to step S404, where the engaged radio devices connect to form a cooperative network of devices.

Processing proceeds to step S406, where node to device association is performed to establish a mesh map of the engaged devices. Establishing the mesh map includes operations corresponding to steps S408 and S410. At step S408, relative device proximity is determined using nearfield radio ranging capability of the radio devices. Further, as step S410, a graph database of engaged radio devices is built based on determined relative device proximities. Ongoing mesh map maintenance is performed by periodic evaluations of relative device proximities. The mesh map is updated when changes in device proximities reaches a threshold change in distances.

Processing proceeds to step S412, where a primary subject, or speaker, is identified using the audio received by microphones of the engaged radio devices. In this example, audio analysis establishes a primary subject by, for example, pre-defined auditory cues are identified by audio analysis.

Processing proceeds to step S414, where a primary microphone role is assigned on one of the radio devices identified in the mesh map.

Processing proceeds to step S416, where background noise microphone roles are assigned to identified radio devices satisfying a background distance condition. Some embodiments of the present invention identify a percentage of mapped devices starting with a device the farthest away from a current speaker or presenter.

Processing proceeds to step S418, where a candidate radio device is identified that may serve as the next primary microphone role. The determination may be made based on audio quality as the speaker moves from one location to another. The determination may be made based on a designated next speaker and corresponding location of the next speaker.

Processing proceeds to step S420, where vocal characteristics are compared between a radio device having the primary microphone role and an identified candidate radio device.

Processing ends at step S422, where reassignment of roles is considered in view of relative locations of engaged devices and corresponding audio quality of a current speaker.

Some embodiments of the present invention are directed to a method for using fine ranging radio devices to locate other fine ranging devices and to build a mesh map by extrapolating the device location data. The mesh map establishes a collaborative space in which the find ranging radio devices can operate to record target speakers. Having built a mesh map, the assigned roles of participating audio devices may be altered based on relative distances and directions of the devices within the collaborative space. According to some embodiments, the mapped devices operate as a set of networked devices in the collaborative space in which a meeting or conference is occurring.

According to an example in which the mapped devices are operating, if a first speaker is on the North side of a conference room, a mapped device having the clearest audio signal of the first speaker is assigned the role of primary microphone, while other participating devices are assigned the role of standby, such that their corresponding microphones may be muted. The primary microphone may be a participating device in the possession of the first speaker.

According to a further embodiment, participating devices located within a threshold proximity to the primary microphone may be assigned the role of silent devices, where the corresponding speakers of the proximate devices are silenced. Silencing the nearby speakers operates to mitigate echoing or feedback from being nearby the primary microphone.

According to still a further embodiment, participating devices on a designated perimeter of the collaborative space may be assigned the role of background device, such that their corresponding microphones are activated to record room noise. The recorded room noise may be applied by noise reduction technology to improve the recording of the first speaker.

According to some embodiments of the present invention, the mesh network establishing a dynamic space of an event resembles a node/edge map, with the nodes representing participating fine ranging devices, and the edges representing the observed distances between the participating devices.

Some embodiments of the present invention are directed to a process for managing participating devices, or nodes, in the mesh network including estimating distances between devices and removing devices as they are no longer observed within the dynamic space of the mesh map. It should be noted that the nature of the mesh network allows for separate groups of nodes to exist within a given node/edge environment, or dynamic space. In this way, a mesh network can grow and flex as new devices are added and subtracted to the network.

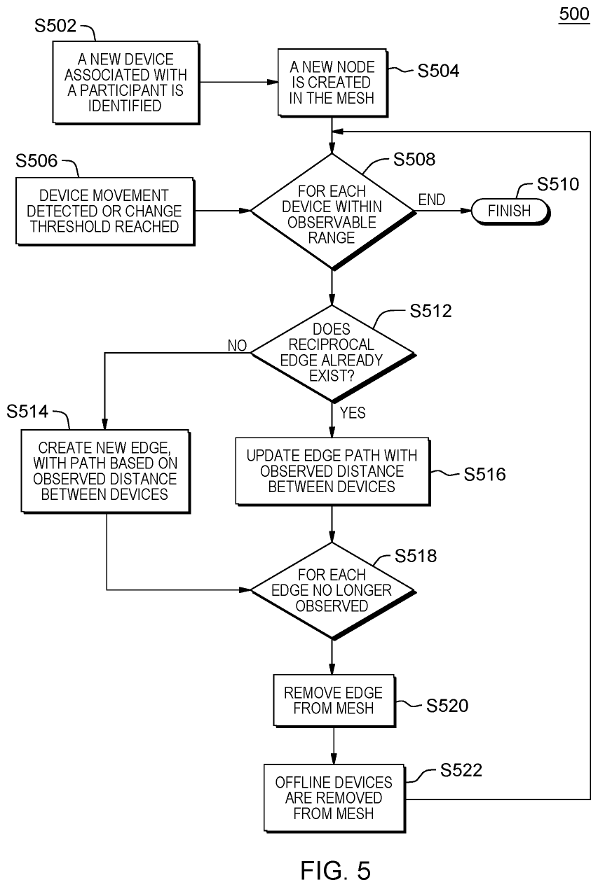

FIG. 5 shows flowchart 500 depicting a second method according to an embodiment of the present invention. This method will now be discussed, over the course of the following paragraphs.

Processing begins at step S502, a new radio device is identified, the new radio device being associated with a meeting participant in an in-person meeting being recorded using multiple radio devices forming a mesh network and monitored for changes in device status.

Processing proceeds to step S504, where the new radio device is established as a new node in the mesh map.

Processing proceeds to step S506, where monitoring mapped devices detects movement. Movement of locations by any mapped device is recorded for comparison to a location change threshold distance. Upon detecting movement of a device and/or a threshold change in relative distances among mapped devices, processing proceeds to step S508, where, for each mapped device, revision of edges in the mesh map are performed in steps S512-S522. When the process including steps S512-S522 are completed for each mapped device, processing ends at step S510.

Processing proceeds to sub-step S512, where a determination is made regarding existence of a reciprocal edge. If a reciprocal edge exists, processing proceeds to sub-step S516, where the edge path is updated with observed relative distances between devices and the existing device. If a reciprocal edge does not exist, processing proceeds to sub-step S514, where a new edge is created with the edge path being based on observed relative distance between devices and the new device.

Regardless of whether a reciprocal edge exists at sub-step S512, processing proceeds from either sub-step S514 or sub-step S516 to sub-step S518, where, for each edge no longer observed, that is, for each mapped device no longer available, processing proceeds to sub-step S520, where the edge is removed from the mesh map. Processing then moves to final sub-step S522, where any offline radio devices are removed from the mesh map.

Processing ends at step S510, as stated above, when each mapped device is processed responsive to device movement, or a threshold change in device(s) location.

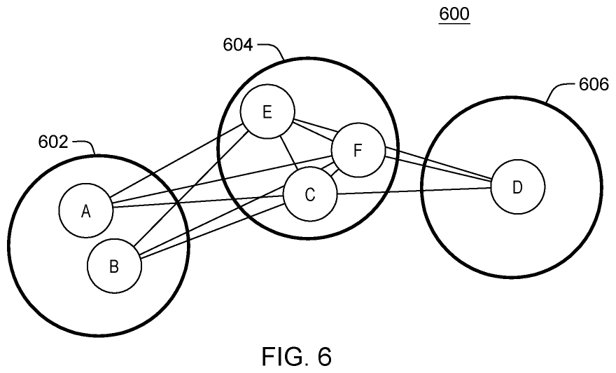

According to some embodiments of the present invention, the roles assigned to nodes expands as the collections of nodes, or networked radio devices, increases. The mesh map grows and flexes as new nodes are added into the network. For example, and with reference to FIG. 6, in a network of three nodes, A, B, and C, where all nodes have full observability between one another, a simple, flat network exists. By factoring in observed relative distances between engaged radio devices, additional shape to the map is created by extrapolation of those distances. Now, when new node D is identified, it may only have an observable link to existing node C. In that way, additional geospatial data can be inferred from the updated mesh map that includes new node D. When new nodes E and F are added to the mesh map and their observed relative distances among the nodes are identified, the mesh map may resemble an actual layout of devices within a event space where the recording will take place. See FIG. 6 for the mesh map including nodes A-F.

Some embodiments of the present invention are directed to a framework for enabling device role assignment. With a mesh network established for identified fine ranging devices, role assignment decisions are made with respect to the dynamic environment in which a meeting or event is being held. These decisions may be made in real time by a facilitator or continuously and automatically when the assignments are enforced by a governing policy. For example, a governing policy may require that a participating device having the role of primary microphone should not be active within five meters of other participating devices having an active speaker.

Some embodiments of the present invention are directed to providing for a target speaker who is being recorded by primary microphones to move about the space in which they are speaking. Further, the audio recorded by the primary microphones may be continually compared with background noise captured by perimeter devices, to obtain the best assignment of roles between them.

Referring again to FIG. 6, mesh map 600 illustrates identified radio devices as nodes A-F with the edge paths representing relative distances between the radio devices as well as available communication paths among the radio devices. Groups 602, 604, and 606 may also be identified in the mesh map to facilitate scaling of the devices used to record audio at an event. Each group of nodes, group A/B 602, group C/E/F 604, and group D 606, may be processed as an individual mesh map, with corresponding change distance thresholds for reviewing and updating current roles of networked devices.

According to some embodiments of the present invention, improving quality of an audio recording may include improving clarity, increasing source volume by proximity to the source, and/or reducing background noise while recording the audio.

Some embodiments of the present invention are directed to a method for obtaining the relative position of fine-ranging devices through the shared observed data from the devices.

Some embodiments of the present invention are directed to leveraging spatial positioning information for creating acoustic recordings from an array of available microphones.

Some embodiments of the present invention are directed to altering assigned roles of available audio devices to improve the presentation environment.

Some embodiments of the present invention are directed to a method for managing an audio recording utilizing nearfield radio ranging including: (a) obtaining a relative position of one or more devices through shared observation data from a plurality of radio devices; (b) leveraging spatial position information for obtaining the optimal acoustic recordings from an array of available of microphones from a plurality of available audio devices; and (c) altering a role of a first available audio device from the plurality of available audio device to facilitate an electronic presentation environment.

Some embodiments of the present invention may include one, or more, of the following features, characteristics and/or advantages: (i) increased recording quality; (ii) enables re-use of assets and efforts; (iii) improves quality of communications for virtual assistant technologies; (iv) conditional assignment of roles to fine ranging devices based on movement of a target speaker within a physical environment ensures an audio recording of the target speaker is a high quality recording; (v) monitoring distance relationships between fine ranging devices and a target speaker within a venue ensures an audio recording of the target speaker is a high quality recording; (vi) monitoring the physical location of speakers and the locations of available fine ranging devices allows for improving quality of an audio recording of the speakers; and (vii) samples non-primary background audio from non-active microphones to identify noise that should be subtracted for improving the recorded audio of a primary source such as the target speaker.

Some embodiments of the present invention are directed to using shared observation data from a plurality of radio devices to assign certain roles to the various radio devices using near-field radio ranging techniques.

Some embodiments of the present invention do more than use speech identification to track a voice as it moves from microphone to microphone.

Some embodiments of the present invention are directed to interpolating location information from fine-ranging (FiRa) UWB devices such that no prior room setup is performed.

Some embodiments of the present invention are directed to a computer-implemented method including: identifying a plurality of radio devices for role assignment; locating a target speaker based on audio signal quality received by the plurality of radio devices; establishing a mesh map of the plurality of radio devices based on shared audio signal data from the plurality of radio devices, the mesh map locating a first device with respect to other devices; and assigning to the first device a role of primary microphone, the first device receiving a higher quality audio signal of the target speaker than the other devices. Performing the above method advantageously increases overall recording quality by ensuring the audio recording of the target speaker is clear.

One aspect of the computer-implemented method disclosed herein may include assigning to a first sub-set of radio devices a role of background audio microphone, the first sub-set of radio devices located, according to the mesh map, within a background distance range from the first device. Performing the above method advantageously increases overall recording quality by ensuring the audio recording of the target speaker is clear. Additionally, or alternatively, this aspect of the present invention advantageously samples non-primary background audio from non-active microphones to identify noise that should be subtracted for improving the recorded audio of a primary source such as the target speaker.

Another aspect of the computer-implemented method disclosed herein may include monitoring audio signal quality of the first device and a second device, the second device being relatively closer to the first device than other devices of the plurality of radio devices; and responsive to the audio quality of the second device being higher than the first device, assigning the second device the role of primary microphone. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording.

Yet another aspect of the computer-implemented method disclosed herein may include identifying a second sub-set of radio devices within an interference distance from the first device, the second sub-set of radio devices including a second device; and assigning to the second sub-set of radio devices a role of inactive speaker, the inactive speaker role muting speaker volume of corresponding radio devices. Performing the above method advantageously increases overall recording quality by ensuring the audio recording of the target speaker is clear. Additionally, or alternatively, this aspect of the present invention advantageously counteracts feedback and/or echo problems with the audio recording.

Still yet another aspect of the computer-implemented method disclosed herein may include responsive to the audio quality of the second device being higher than the first device, assigning to the second device the role of primary microphone; and assigning to the first device the role of inactive speaker. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording. Additionally, or alternatively, this aspect of the present invention advantageously counteracts feedback and/or echo problems with the audio recording.

A further aspect of the computer-implemented method disclosed herein may include updating an edge path of the mesh map based on a detected change in distance between the first device and a second device of the plurality of radio devices, the detected change in distance being based on a comparison of vocal characteristics of the primary speaker received by the first and second devices. Performing the above method advantageously increases overall recording quality by ensuring the audio recording of the target speaker is clear. Additionally, or alternatively, this aspect of the present invention advantageously enables re-use of assets and efforts. Additionally, or alternatively, this aspect of the present invention advantageously provides for conditional assignment of roles to fine ranging devices based on movement of a target speaker within a physical environment ensures an audio recording of the target speaker is a high-quality recording.

Some embodiments of the present invention are directed toward a computer program product comprising a computer-readable storage medium having a set of instructions stored therein which, when executed by a processor, causes the processor to perform a method including identifying a plurality of radio devices for role assignment; locating a target speaker based on audio signal quality received by the plurality of radio devices; establishing a mesh map of the plurality of radio devices based on shared audio signal data from the plurality of radio devices, the mesh map locating a first device with respect to other devices; and assigning to the first device a role of primary microphone, the first device receiving a higher quality audio signal of the target speaker than the other devices. Performing the above method advantageously increases overall recording quality by ensuring the audio recording of the target speaker is clear.

One aspect of the computer program product may further cause the processor to perform a method including assigning to a first sub-set of radio devices a role of background audio microphone, the first sub-set of radio devices located, according to the mesh map, within a background distance range from the first device. Performing the above method advantageously increases overall recording quality by ensuring the audio recording of the target speaker is clear. Additionally, or alternatively, this aspect of the present invention advantageously samples non-primary background audio from non-active microphones to identify noise that should be subtracted for improving the recorded audio of a primary source such as the target speaker.

Another aspect of the computer program product may further cause the processor to perform a method including monitoring audio signal quality of the first device and a second device, the second device being relatively closer to the first device than other devices of the plurality of radio devices; and responsive to the audio quality of the second device being higher than the first device, assigning the second device the role of primary microphone. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording.

Yet another aspect of the computer program product may further cause the processor to perform a method including identifying a second sub-set of radio devices within an interference distance from the first device, the second sub-set of radio devices including a second device; and assigning to the second sub-set of radio devices a role of inactive speaker, the inactive speaker role muting speaker volume of corresponding radio devices. Performing the above method advantageously increases overall recording quality by ensuring the audio recording of the target speaker is clear. Additionally, or alternatively, this aspect of the present invention advantageously counteracts feedback and/or echo problems with the audio recording.

Still yet another aspect of the computer program product may further cause the processor to perform a method including responsive to the audio quality of the second device being higher than the first device, assigning to the second device the role of primary microphone; and assigning to the first device the role of inactive speaker. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording. Additionally, or alternatively, this aspect of the present invention advantageously counteracts feedback and/or echo problems with the audio recording.

A further aspect of the computer program product may further cause the processor to perform a method including updating an edge path of the mesh map based on a detected change in distance between the first device and a second device of the plurality of radio devices, the detected change in distance being based on a comparison of vocal characteristics of the primary speaker received by the first and second devices. Performing the above method advantageously increases overall recording quality by ensuring the audio recording of the target speaker is clear. Performing the above method advantageously increases overall recording quality by ensuring the audio recording of the target speaker is clear. Additionally, or alternatively, this aspect of the present invention advantageously enables re-use of assets and efforts. Additionally, or alternatively, this aspect of the present invention advantageously provides for conditional assignment of roles to fine ranging devices based on movement of a target speaker within a physical environment ensures an audio recording of the target speaker is a high-quality recording.

Some embodiments of the present invention are directed toward a computer system including: a processor set; and a computer readable storage medium. The processor set is structured, located, connected, and/or programmed to run program instructions stored on the computer readable storage medium. The program instructions, when executed by the processor set, cause the processor set to perform a method including identifying a plurality of radio devices for role assignment; locating a target speaker based on audio signal quality received by the plurality of radio devices; establishing a mesh map of the plurality of radio devices based on shared audio signal data from the plurality of radio devices, the mesh map locating a first device with respect to other devices; and assigning to the first device a role of primary microphone, the first device receiving a higher quality audio signal of the target speaker than the other devices. Performing the above method advantageously increases overall recording quality by ensuring the audio recording of the target speaker is clear.

One aspect of the computer system may further cause the processor to perform a method including assigning to a first sub-set of radio devices a role of background audio microphone, the first sub-set of radio devices located, according to the mesh map, within a background distance range from the first device. Performing the above method advantageously increases overall recording quality by ensuring the audio recording of the target speaker is clear. Additionally, or alternatively, this aspect of the present invention advantageously samples non-primary background audio from non-active microphones to identify noise that should be subtracted for improving the recorded audio of a primary source such as the target speaker.

Another aspect of the computer system may further cause the processor to perform a method including monitoring audio signal quality of the first device and a second device, the second device being relatively closer to the first device than other devices of the plurality of radio devices; and responsive to the audio quality of the second device being higher than the first device, assigning the second device the role of primary microphone. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording.

Yet another aspect of the computer system may further cause the processor to perform a method including identifying a second sub-set of radio devices within an interference distance from the first device, the second sub-set of radio devices including a second device; and assigning to the second sub-set of radio devices a role of inactive speaker, the inactive speaker role muting speaker volume of corresponding radio devices. Performing the above method advantageously increases overall recording quality by ensuring the audio recording of the target speaker is clear. Additionally, or alternatively, this aspect of the present invention advantageously counteracts feedback and/or echo problems with the audio recording.

Still yet another aspect of the computer system may further cause the processor to perform a method including responsive to the audio quality of the second device being higher than the first device, assigning to the second device the role of primary microphone; and assigning to the first device the role of inactive speaker. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording. Additionally, or alternatively, this aspect of the present invention advantageously counteracts feedback and/or echo problems with the audio recording.

A further aspect of the computer system may further cause the processor to perform a method including updating an edge path of the mesh map based on a detected change in distance between the first device and a second device of the plurality of radio devices, the detected change in distance being based on a comparison of vocal characteristics of the primary speaker received by the first and second devices. Performing the above method advantageously increases overall recording quality by ensuring the audio recording of the target speaker is clear. Performing the above method advantageously increases overall recording quality by ensuring the audio recording of the target speaker is clear. Additionally, or alternatively, this aspect of the present invention advantageously enables re-use of assets and efforts. Additionally, or alternatively, this aspect of the present invention advantageously provides for conditional assignment of roles to fine ranging devices based on movement of a target speaker within a physical environment ensures an audio recording of the target speaker is a high-quality recording.

According to a combination of aspects of the computer-implemented method disclosed herein, the combination may include first, identifying a second sub-set of radio devices within an interference distance from the first device, the second sub-set of radio devices including a second device; and assigning to the second sub-set of radio devices a role of inactive speaker, the inactive speaker role muting speaker volume of corresponding radio devices. Performing the above method advantageously increases overall recording quality by ensuring the audio recording of the target speaker is clear. Additionally, or alternatively, this aspect of the present invention advantageously counteracts feedback and/or echo problems with the audio recording. And may include, second responsive to the audio quality of the second device being higher than the first device, assigning to the second device the role of primary microphone; and assigning to the first device the role of inactive speaker. Performing the above method advantageously increases overall recording quality by ensuring the audio recording of the target speaker is clear. Additionally, or alternatively, this aspect of the present invention advantageously provides for conditional assignment of roles to fine ranging devices based on movement of a target speaker within a physical environment ensures an audio recording of the target speaker is a high-quality recording. Additionally, or alternatively, this aspect of the present invention advantageously counteracts feedback and/or echo problems with the audio recording.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above-similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine-readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a plurality of radio devices for role assignment;
locating a target speaker based on audio signal quality received by the plurality of radio devices;
establishing a mesh map of the plurality of radio devices based on shared audio signal data from the plurality of radio devices, the mesh map locating a first device with respect to other devices; and
assigning to the first device a role of primary microphone, the first device receiving a higher quality audio signal of the target speaker than the other devices.

2. The computer-implemented method of claim 1, further comprising:
assigning to a first sub-set of radio devices a role of background audio microphone, the first sub-set of radio devices located, according to the mesh map, within a background distance range from the first device.

3. The computer-implemented method of claim 1, wherein the plurality of radio devices are fine-ranging (FiRa) radio devices.

4. The computer-implemented method of claim 1, further comprising:
monitoring audio signal quality of the first device and a second device, the second device being relatively closer to the first device than other devices of the plurality of radio devices; and
responsive to the audio quality of the second device being higher than the first device, assigning the second device the role of primary microphone.

5. The computer-implemented method of claim 1, further comprising:
identifying a second sub-set of radio devices within an interference distance from the first device, the second sub-set of radio devices including a second device; and
assigning to the second sub-set of radio devices a role of inactive speaker, the inactive speaker role muting speaker volume of corresponding radio devices.

6. The computer-implemented method of claim 5, further comprising:
responsive to the audio quality of the second device being higher than the first device, assigning to the second device the role of primary microphone; and
assigning to the first device the role of inactive speaker.

7. The computer-implemented method of claim 1, further comprising:
updating an edge path of the mesh map based on a detected change in distance between the first device and a second device of the plurality of radio devices, the detected change in distance being based on a comparison of vocal characteristics of the primary speaker received by the first and second devices.

8. The computer-implemented method of claim 1, further comprising:
identifying a third sub-set of radio devices beyond an interference distance from the first device; and
assigning to the third sub-set of radio devices a role of speaker system, the role of speaker system turning on the speakers of assigned devices to emit audio received by the first device having a role of primary microphone.

9. A computer program product comprising a computer-readable storage medium having a set of instructions stored therein which, when executed by a processor, causes the processor to perform a method comprising:
identifying a plurality of radio devices for role assignment;
locating a target speaker based on audio signal quality received by the plurality of radio devices;
establishing a mesh map of the plurality of radio devices based on shared audio signal data from the plurality of radio devices, the mesh map locating a first device with respect to other devices; and
assigning to the first device a role of primary microphone, the first device receiving a higher quality audio signal of the target speaker than the other devices.

10. The computer program product of claim 9, further causing the processor to perform a method comprising:
assigning to a first sub-set of radio devices a role of background audio microphone, the first sub-set of radio devices located, according to the mesh map, within a background distance range from the first device.

11. The computer program product of claim 9, further causing the processor to perform a method comprising:
monitoring audio signal quality of the first device and a second device, the second device being relatively closer to the first device than other devices of the plurality of radio devices;
responsive to the audio quality of the second device being higher than the first device, assigning the second device the role of primary microphone.

12. The computer program product of claim 9, further causing the processor to perform a method comprising:
identifying a second sub-set of radio devices within an interference distance from the first device, the second sub-set of radio devices including a second device;
assigning to the second sub-set of radio devices a role of inactive speaker, the inactive speaker role muting speaker volume of corresponding radio devices.

13. The computer program product of claim 12, further causing the processor to perform a method comprising:
responsive to the audio quality of the second device being higher than the first device, assigning to the second device the role of primary microphone; and
assigning to the first device the role of inactive speaker.

14. The computer program product of claim 9, further causing the processor to perform a method comprising:
updating an edge path of the mesh map based on a detected change in distance between the first device and a second device of the plurality of radio devices, the detected change in distance being based on a comparison of vocal characteristics of the primary speaker received by the first and second devices.

15. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
identifying a plurality of radio devices for role assignment;
locating a target speaker based on audio signal quality received by the plurality of radio devices;
establishing a mesh map of the plurality of radio devices based on shared audio signal data from the plurality of radio devices, the mesh map locating a first device with respect to other devices; and
assigning to the first device a role of primary microphone, the first device receiving a higher quality audio signal of the target speaker than the other devices.

16. The computer system of claim 15, further causing the processor to perform a method comprising:
assigning to a first sub-set of radio devices a role of background audio microphone, the first sub-set of radio devices located, according to the mesh map, within a background distance range from the first device.

17. The computer system of claim 15, further causing the processor to perform a method comprising:
monitoring audio signal quality of the first device and a second device, the second device being relatively closer to the first device than other devices of the plurality of radio devices;
responsive to the audio quality of the second device being higher than the first device, assigning the second device the role of primary microphone.

18. The computer system of claim 15, further causing the processor to perform a method comprising:
identifying a second sub-set of radio devices within an interference distance from the first device, the second sub-set of radio devices including a second device;
assigning to the second sub-set of radio devices a role of inactive speaker, the inactive speaker role muting speaker volume of corresponding radio devices.

19. The computer system of claim 18, further causing the processor to perform a method comprising:
responsive to the audio quality of the second device being higher than the first device, assigning to the second device the role of primary microphone; and
assigning to the first device the role of inactive speaker.

20. The computer system of claim 15, further causing the processor to perform a method comprising:
updating an edge path of the mesh map based on a detected change in distance between the first device and a second device of the plurality of radio devices, the detected change in distance being based on a comparison of vocal characteristics of the primary speaker received by the first and second devices.
